(19) United States
(12) Patent Application Publication
(10) Pub. No.: US 2005/0286173 A1
(43) Pub. Date: Dec. 29, 2005

(54) Stop with adjustable stiffness

(76) Inventors: Ryan Todd Ratliff, Oklahoma City, OK (US); Curtis Trammell, Newcastle, OK (US); John Daniel Stricklin, Oklahoma City, OK (US)

Correspondence Address: Derek J. Berger;Seagate Technology LLC, Intellectual Property - COL2LGL, 389 Disc Drive, Longmont, CO, 80503, US

(21) Appl. No.: 10/879,246

(22) Filed: Jun. 29, 2004

(51) Int. Cl. G11B 5/54

(52) U.S. Cl. 360/265.1

(57) ABSTRACT

The present invention provides an adjustable crash stop. The stiffness or load of the crash stop may be varied by rotating the stop and thereby varying the point of contact between the actuator assembly and the crash stop. The point of contact is on an arcuate contact surface of a cantilever supported spring. The spring is supported by a stem that can be positioned in several different rotational positions such that the contact point is at different locations on the contact surface. The stiffness at each contact point changes as its distance from the hinge point of the spring changes.

### FIELD OF THE INVENTION

This application relates generally to movable actuators and more particularly to a crash stop assembly for a movable actuator.

### BACKGROUND OF THE INVENTION

In an apparatus such as a disc drive, information is written to and read from tracks on data storage device discs through the use of a pivoting actuator assembly. The actuator assembly includes heads, which each move in close proximity above the corresponding surface of the associated disc. A voice coil motor controls the track position of the heads by pivoting the actuator assembly. The voice coil motor typically includes a coil attached to the actuator assembly, as well as one or more permanent magnets, which establish a magnetic field in which the coil is immersed. A bottom pole proximal the data storage device base plate and a top pole distal from the base plate typically establishes the magnetic field. The controlled application of current to the coil causes magnetic interaction between the permanent magnets and the coil so that the actuator assembly pivots.

Various approaches have been developed to securely position an actuator assembly in such an apparatus during a loss of power event or shutdown of the drive such that the heads do not land on a portion of the disc real estate that contains data. Typically these approaches involve either positioning the actuator assembly onto a shelf to hold the heads away from the discs or positioning the heads over portions of the disc surfaces that contain no data, such as the landing zones of the discs. The landing zones typically contain no magnetic recorded information or alternatively contain only historical servo information that is not pertinent to drive operation if damaged by the heads actually contacting the surfaces of the discs in this location. Approaches for holding the arm assembly in such as “park” position include mechanical latches, electromechanical latches and magnetic latches.

To limit the range of motion of the actuator and heads under loss of power conditions and keep the heads in the landing zone, designers usually incorporate crash stops and a latch mechanism to position and hold the arm in the park position while the drive is without power. One concern in providing a latch and crash stop assembly is the level of energy absorbed by the crash stops. It is desirable that the crash stops absorb the impact of the actuator assembly as it stops without detrimentally affecting the head disc interface, even though the actuator assembly is designed to stop in a position away from the data region of the discs where the heads are parked. If excessive impact were to occur, the heads or the disc surface itself could be damaged by head slap. In addition, the actuator arm inertia and the impact energy varies depending on the individual deck design. This generally requires separate crash stop design to accommodate the change in impact energy, thereby increasing design and tooling costs.

Accordingly, there is a need for a crash stop assembly with uniform design able to provide varying degrees of stiffness. The present invention provides a solution to this and other problems, and offers other advantages as well.

### SUMMARY OF THE INVENTION

One embodiment of the present invention may be viewed as an apparatus in which a pivotally supported actuator assembly mounted on the base plate, and one or more rotationally adjustable crash stops for limiting pivotal movement of the actuator assembly. Alternatively, the crash stops may be located in the base of the actuator assembly which is then attached to the data storage device base plate.

These and various other features as well as advantages which characterize the present invention will be apparent from a reading of the following detailed description and a review of the associated drawings.

### BRIEF DESCRIPTION OF THE DRAWINGS

FIG. 1 is a partially broken away plan view of a data storage device incorporating an embodiment of the present invention showing select primary internal components.

FIG. 2 is a plan view of the embodiment of the crash stop in accordance with the present invention shown in FIG. 1 separate from the data storage device.

FIG. 3 is a perspective view of the crash stop shown in FIG. 2.

FIG. 4 is a top view of an actuator arm assembly with a crash stop of the present invention inserted into the bottom pole plate of the voice coil motor fastened to the base plate of the data storage device along with top views of the crash stop showing various alternate points of contact between the actuator arm and the impact portion of the crash stop.

FIG. 5 is a perspective exploded view of the actuator arm assembly and crash stop shown in FIG. 4 showing a slotted aperture in the bottom pole plate (or in the base plate) receiving the crash stop in accordance with an embodiment of the present invention.

### DETAILED DESCRIPTION

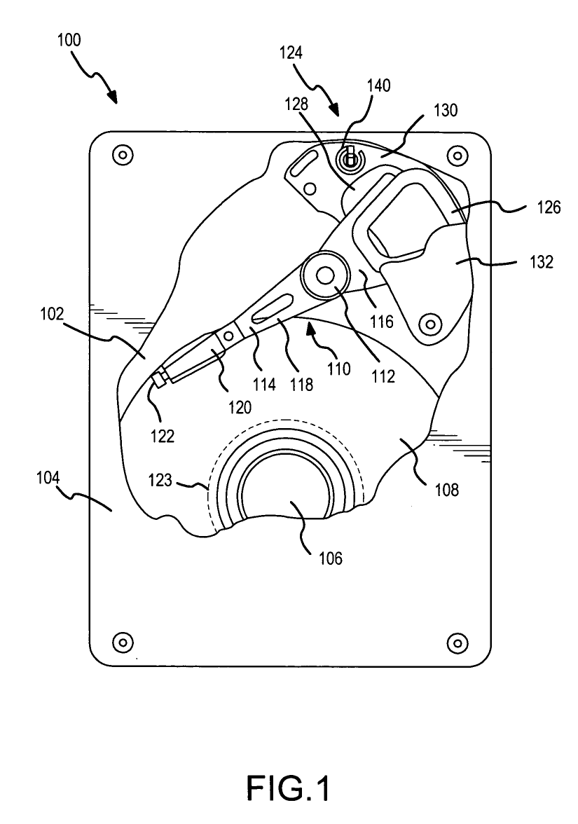

Referring to FIG. 1, data storage device 100 includes a base plate 102 to which various components of the data storage device 100 are mounted. A top cover 104, shown partially cut away, cooperates with the base plate 102 to form an internal, sealed environment for the data storage device 100 in a conventional manner. The components include a spindle motor 106, which rotates one or more discs 108 at a constant high speed. Information is written to and read from tracks on the discs 108 through the use of an actuator assembly 110, which rotates during a seek operation about pivot or bearing shaft assembly 112 positioned adjacent the discs 108. The actuator assembly 110 includes a head aspect 114 extending forwardly from the pivot 112 and a motor aspect 116 extending rearwardly from the pivot 112. The head aspect 114 includes a plurality of actuator arms 118 which extend towards the discs 108, with one or more flexures 120 extending from each of the actuator arms 118. Mounted at the distal end of each of the flexures 120 is a head 122, which includes an air bearing slider enabling the head 122 to fly in close proximity above the corresponding surface of the associated disc 108.

During a seek operation, the track position of the heads 122 is controlled through the use of a voice coil motor 124, which typically includes a coil 126 attached to the motor aspect 116 of the actuator assembly 110, as well as one or more permanent magnets 128, which establish a magnetic field in a gap in which the coil 126 is immersed. The magnetic field is typically established through a bottom pole plate 130 mounted on the base plate 102, which includes a permanent magnet 128 thereon, and a top pole 132, shown partially cut away, spaced from the base plate 102, which also includes a permanent magnet 128. The controlled application of current to the coil 126 causes magnetic interaction between the permanent magnets 128 and the coil 126 so that the coil 126 moves back and forth in the gap between the magnets 128 in accordance with the well-known Lorentz relationship. As the coil 126 moves, the actuator assembly pivots about the bearing shaft assembly 112, and the heads 122 are caused to move across the surfaces of the discs 108.

The spindle motor 106 is typically de-energized when the data storage device 100 is not in use for extended periods of time. The heads 122 are moved over park zones or landing zones 123 near the inner diameter of the discs 108 when the drive motor is de-energized. The heads 122 are secured over the park zones 123 through the use of an actuator latch arrangement (not shown), which prevents inadvertent rotation of the actuator assembly 110 when the heads are parked. A crash stop assembly 140 limits pivotal movement of the actuator assembly 110. Alternatively, or in addition, the data storage device may comprise a crash stop located on the opposite side of the actuator assembly to limit the outward movement of the heads 122. Such a design may be desirable, for example, where the parking zone consists of a ramp located adjacent the outer periphery of the discs 108.

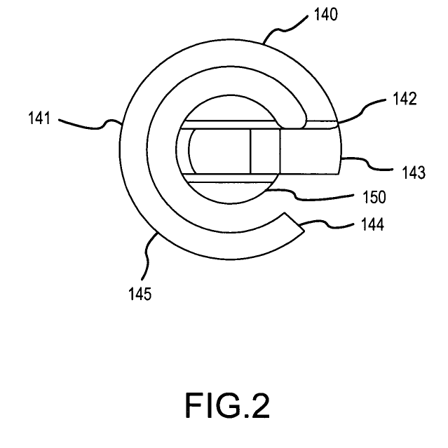

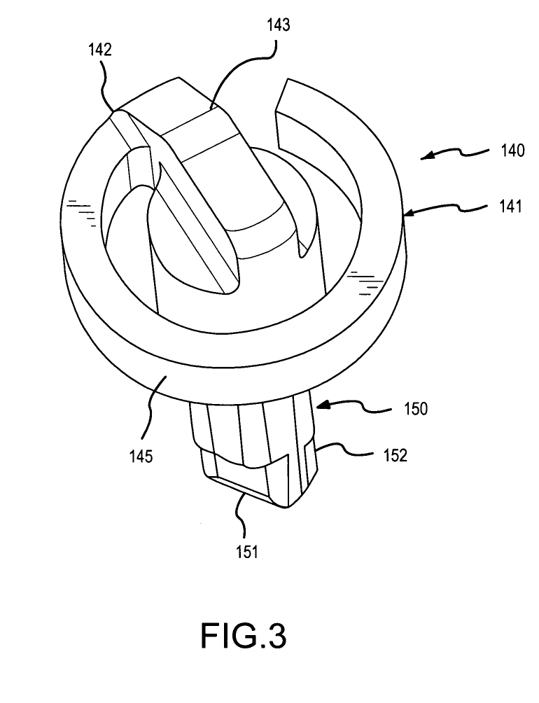

FIGS. 2 and 3 show two views of one embodiment of a crash stop 140 in accordance with the invention. As shown in the top view (FIG. 2), the crash stop 140 includes a spring portion 141 that wraps around, i.e. extends substantially circumferentially, around the stem portion 150. The crash stop 140 has a spring support 143 radially supporting the spring portion 141 from the stem portion and a hinge area 142 joining the spring support 143 and the spring portion 141. Preferably, the spring 141 extends circumferentially about the stem 150 such that the arc formed from the hinge area 142 to the terminal portion 144 is at least about 180°, and more preferably, at least about 270°. The spring 141 may extend fully around the stem 150 in an arc provided that the spring retains the ability to flex upon impact with the actuator assembly. Thus, the terminal portion 144 should not come in contact with the spring support 143. The crash stop 140 is preferably made of a molded plastic material although other materials may be used such as metal. A combination of materials may also be used such as a metal spring attached to a plastic stem. The thickness, width and height of the spring portion of the crash stop 140 can be varied to obtain the overall range of desired spring characteristics. The outer curved surface of the spring portion 141 forms a contact surface 145. The actual point of contact depends on the rotational position of the crash stop.

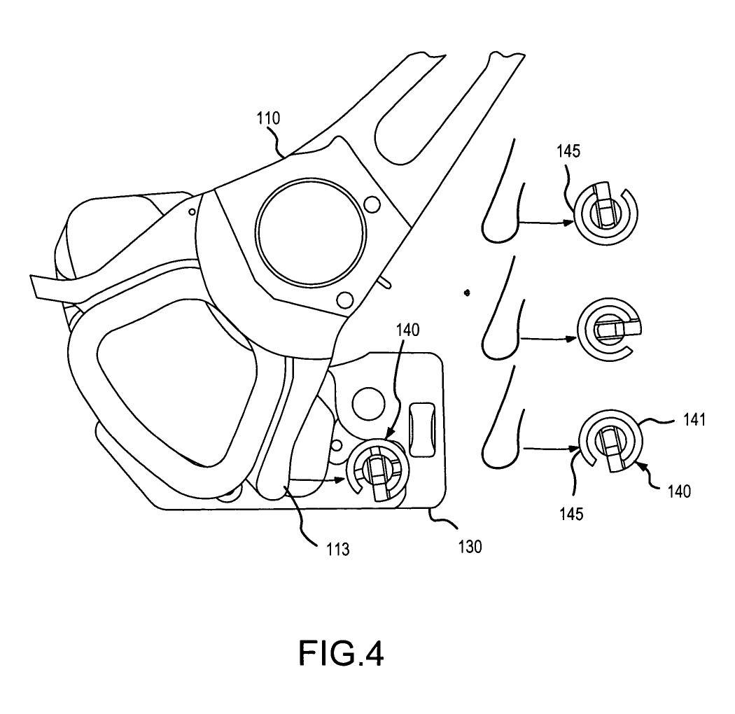

FIG. 3 is a perspective view of crash stop 140. The bottom end of the stem 150 is preferably shaped to form a key, and in the illustrated embodiment, a generally rectangular key that has parallel vertical surfaces 151,152 on the lower portion of the stem 150. FIG. 4 shows a top view of the actuator assembly 110 relative to the location of crash stop 140 mounted on the pole plate 130. It is to be understood that the pole plate 130 may be shorter than that shown, such that the crash stop 140 is fastened directly to the base plate 102 rather than via the pole plate 130. Also shown in FIG. 4 are insets showing alternative rotational positions of the crash stop 140 that change the contact point of the contact arm 113 with the impact surface 145 of the spring portion 141. The stiffness of the spring 140 will decrease as the contact point moves further from the hinge area. The amount of stiffness seen by the actuator 110 when contact arm 113 contacts the crash stop 140 depends on the length of the spring portion 141 between the contact point and the hinge area 142. The closer the contact point is to the hinge area 142, the greater the stiffness. The further the contact point is from the hinge area 142, the less the stiffness, hence more cushion or resilient, the effect will be on the actuator contact arm 113 during contact. Since the contact surface 145 of the spring portion 141 extends in an arc around the stem 150, the stiffness of the crash stop 140 that the actuator assembly 110 sees can be varied by simply changing the rotational position of the crash stop 140 about its axis relative to the actuator assembly.

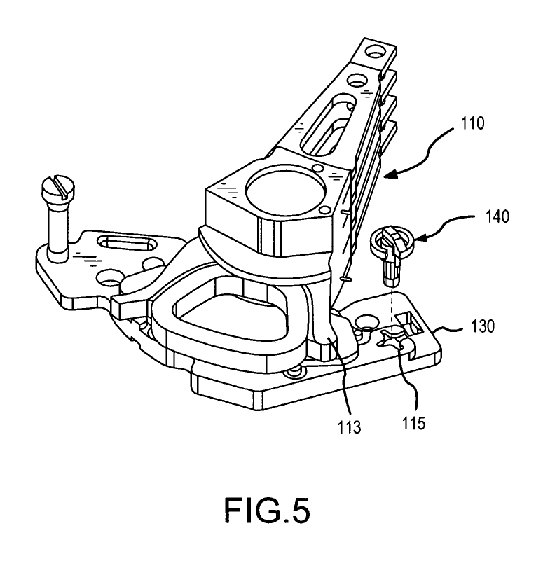

FIG. 5 is a perspective exploded view of the actuator assembly 110 and crash stop 140. In this particular embodiment, aperture 115 in the pole plate 130 (or alternatively in the base plate 102) is defined by two intersecting perpendicular slots. This “cross shaped” aperture permits the key shaped bottom end of the stem 150 to fit in four orientations resulting in four positions of crash stop 140, each position being offset from the next by 90 degrees. Additional slots may be added to increase the number of rotational positions of the crash stop 140 in the aperture 115. Preferably, the aperture is machined into the base of the data storage device or base of the actuator assemble, as the case may be.

Alternatively, the bottom portion of the stem 150 may be substantially cylindrical in shape. In this manner, the crash stop could be rotated to essentially any position within the 360 degree arc defined by the aperture. The aperture 115 in this case would be a smooth bore and the stem may be smooth to allow for limitless rotation. In this alternative embodiment, a securing means (not shown) would be needed to secure the crash stop in the desired position. Alternatively, the surfaces of the stem and aperture may comprise small flexible teeth that engage one another and allow position change by “clicking” from one rotational position to the next. Alternatively the teeth may also be inflexible, i.e. closely spaced splines that intermesh such that the crash stop must be rotated to the selected position, and then inserted into the complementary shaped aperture such that the teeth or splines are engaged and the crash stop cannot be further rotated while in this engaged position.

It will be clear that the present invention is well adapted to attain the ends and advantages mentioned as well as those inherent therein. Numerous other changes may be made which will readily suggest themselves to those skilled in the art and which are encompassed in the spirit of the invention disclosed and as defined in the appended claims.

1. An apparatus comprising:
a base;
a movable actuator for positioning an element with respect to the base; and
a resilient stop fixed to the base and configured to be contacted by the actuator at a contact point, the resiliency of the stop at the contact point being adjustable and the contact point being fixed with respect to the base regardless of the resiliency of the stop.

2. The apparatus of claim 1, in which the resiliency of the stop is configured to be adjusted by rotating the stop.

3. The apparatus of claim 1, in which the resiliency of the stop is configured to be adjusted by rotating the stop about an axis which is orthogonal to a surface of the base to which the stop is fixed.

4. The apparatus of claim 1, in which the resilient stop comprises:
a mounting portion for fixing the stop to the base; and
a resilient portion for being contacted by the actuator, the resilient portion being supported by the mounting portion.

5. The apparatus of claim 4, in which the base comprises an aperture and the mounting portion comprises an insert portion, the insert portion being configured for insertion into the aperture to fix the stop to the base.

6. The apparatus of claim 5, in which the aperture has a shape complementary to that of the insert portion.

7. The apparatus of claim 5, in which the aperture is defined by at least two intersecting slots.

8. The apparatus of claim 7 wherein the two intersecting slots are perpendicular to each other.

9. The apparatus of claim 4, in which the mounting portion comprises an elongate stem, the resiliency of the stop being configured to be adjusted by rotating the stop about the axis of the stem.

10. The apparatus of claim 4, in which the resilient portion comprises a spring, the spring further comprising:
a first end fixed to the mounting portion; and
a second end.

11. The apparatus of claim 10, in which the spring is curved.

12. The apparatus of claim 11, in which the curved spring follows an arc of at least 180 degrees.

13. The apparatus of claim 12, in which the curved spring follows an arc of at least 270 degrees.

14. The apparatus of claim 10, in which the second end is free.

15. The apparatus of claim 1, further comprising:
a storage medium mounted to the base, the element being configured to read and/or write data on the storage medium.

16. The apparatus of claim 15, in which the storage medium is magnetic.

17. The apparatus of claim 15, in which the storage medium comprises a rotatable disc.

18. The apparatus of claim 15, in which the crash stop is mounted adjacent the actuator on a pole plate fastened to the base.

19. The apparatus device of claim 18 wherein the pole plate has an aperture receiving a mounting portion of the stop.

20. The apparatus of claim 1, in which the actuator is rotatable about an axis.
